(19) United States
(12) Patent Application Publication
(10) Pub. No.: US 2008/0167048 A1
(43) Pub. Date: Jul. 10, 2008

(54) METHOD, DEVICE AND NETWORK FOR BASE STATION CONTROLLER MULTI-HOMING IN CDMA2000

(75) Inventors: Wenyu LIU, Shenzhen (CN); Fang YOU, Shenzhen (CN); Jie XU, Shenzhen (CN); Hua WEI, Shenzhen (CN); Yan LI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/053,095

(22) Filed: Mar. 21, 2008

Related U.S. Application Data
(63) Continuation of application No. PCT/CN2006/002496, filed on Sep. 22, 2006.

(30) Foreign Application Priority Data
Sep. 23, 2005 (CN) 200510104900.1

(51) Int. Cl. H04Q 7/20

(52) U.S. Cl. 455/445

(57) ABSTRACT

A method, device and system for implementing Base Station Controller (BSC) multi-homing in CDMA2000 are disclosed. Using the method, a BSC can be controlled to be homed to various Mobile Switching Centers (MSCs) based on the mapping relationships between mobile subscribers and MSCs. A plurality of MSC interfacing units for interchanging information with a plurality of MSCs can be arranged on the BSC. According to the present invention, a BSC multi-homing service in the field of CDMA2000, which has the benefits of load balance, disaster tolerance, CD interface traffic reduction, inter-office handover reduction, etc., can be implemented.

### CROSS-REFERENCE TO RELATED APPLICATIONS

This application is a continuation of International Patent Application No. PCT/CN2006/002496, filed Sep. 22, 2006, which claims priority to Chinese Patent Application No. 200510104900.1, filed Sep. 23, 2005, both of which are hereby incorporated by reference in their entirety.

### FIELD OF THE INVENTION

The present invention relates to the field of mobile communications, and in particular to a method, device and network for base station controller (BSC) multi-homing in CDMA2000.

### BACKGROUND OF THE INVENTION

A circuit domain in an existing CDMA2000 network is of star-shaped configuration, in other words, one BSC can be connected to only one Mobile Switching Center (MSC), and one MSC can be connected to a plurality of BSCs, as shown in FIG. 1. Presently, the capacity of MSCs is becoming increasingly larger. If a malfunction or an overload occurs in one MSC, all of the subordinate BSCs in the same network will be inactive, thus having a great impact on the network.

A method called ISPAGING that is described in ANSI41D protocol has been proposed in the related art. FIG. 2 is a flow chart of ISPAGING, including the following.

Steps a, b, c and d are normal called party routing processes, and Step e is a paging process. If there is no response to a paging, Step f will be performed. In Step a, an MSC receives a call origination. In Step b, the MSC requests a mobile subscriber location from a Home Location Register (HLR). In Step c and d, the HLR retrieves a roaming number from the MSC to which the called mobile subscriber registers.

In Step f, the MSC transfers the registered location area to an adjacent MSC.

In Step g, the adjacent MSC pages in a location area adjacent to the registered location area and receives a user response.

In Step h, i, j and k, the adjacent MSC retrieves user data from the HLR.

In Step l, the adjacent MSC feeds the roaming number and MSCID back to the MSC.

Steps m, n and o are normal returning routing processes. In step m and n, the called MSC returns the roaming number to the HLR. In step o, the HLR feeds the roaming number TLDN of the called party back to the calling party.

Steps p, q, r, s, t, u, v and w are registering processes triggered by the fact that the user has roamed to the adjacent MSC.

Step x is a normal call setup process.

FIG. 3 is a flow chart illustrating a process in which a BSC registers to an MSC in the related art. The process is as follows:

the BSC transmits a registering message carrying an International Mobile Subscriber Identification (IMSI), location area information and a signaling transport layer connection number to the MSC;

the MSC feeds a message carrying the signaling transport layer connection number back to the BSC for indicating that the registering has been accepted; the BSC identifies which registering has been accepted according to the signaling transport layer connection number.

FIG. 4 is a flow chart illustrating a process in which a BSC initiates a call to an MSC in the related art. The process is as follows:

the BSC transmits a service request message carrying an IMSI and a transport layer connection number to the MSC;

the MSC requests the BSC to assign an air channel carrying the transport layer connection number; the BSC feeds a message carrying the transport layer connection number back to the MSC for indicating that the air channel assignation has been completed.

FIG. 5 is a flow chart illustrating a process in which a BSC is called in the related art. The process is as follows:

an MSC initiates a paging request carrying a user IMSI to a BSC;

the BSC feeds a paging response carrying the user IMSI and the transport layer connection number back to the MSC;

the MSC requests the BSC to assign an air channel carrying the transport layer connection number;

the BSC feeds a message carrying the transport layer connection number back to the MSC for indicating that the air channel assignation has been completed.

the BSC feeds a message carrying the transport layer connection number to the MSC for indicating that the user has been connected.

In the related art, there is provided a solution for implementing a BSC multi-homing service in the field of WCDMA. FIG. 6 is a schematic diagram illustrating a network structure used in the solution. In the network, a Radio Access Network (RAN) corresponds to a BSC in CDMA2000, whereas there is no device corresponding to a serving GPRS support node (SGSN) in CDMA2000. In FIG. 6, it can be seen that one RAN may be homed to a plurality of MSCs.

When a user registers in a roaming place for the first time, the RAN calculates an MSC number from the user IMSI according to a rule configured statically by an operator, and forwards a registering message to the MSC for registering, and then the MSC returns a TMSI to the user. If the user calls or registers again subsequently, a message carrying a TMSI is generated. The RAN finds out the MSC at which the user is located according to the TMSI and forwards this message. In some cases, if the MSC wishes to transfer the user to another MSC, it will return a virtual TMSI when the user is registering and informing the user to initiate a second registering. A message carrying the virtual TMSI will be transmitted to the RAN, and then the RAN reassigns a new MSC to the user according to the virtual TMSI and forwards that message to the new MSC. The new MSC returns a TMSI to be carried in subsequent messages, and then the RAN forwards the subsequent messages to correct MSCs according to the TMSI.

In the related art, the TMSI mechanism specific to WCDMA is used to achieve multi-homing characteristic, network load sharing and user transferring. However, there is no TMSI in CDMA2000, so it is necessary to define a new mechanism to implement a multi-homing service.

### SUMMARY OF THE INVENTION

Embodiments of the present invention provide a method, network and device for implementing Base Station Controller (BSC) multi-homing in CDMA2000 and a BSC for implementing multi-homing so as to overcome the problem in which BSC multi-homing cannot be implemented in CDMA 2000.

The method for implementing BSC multi-homing in CDMA2000 includes:

setting a mapping relationship between a mobile subscriber and a Mobile Switching Center (MSC), receiving a message carrying the mobile subscriber identity, searching for the mapping relationship according to the mobile subscriber identity to obtain a first MSC corresponding to the mobile subscriber, and forwarding the message to the first MSC.

The searching for the mapping relationship includes looking up a number segment configuration table; wherein, the mapping relationship between the mobile subscriber and the MSC, International Mobile Subscriber Identification (IMSI) number information of the mobile subscriber, and a corresponding MSC identification are arranged in the number segment configuration table.

The mobile subscriber IMSI number information includes one or more mobile subscriber IMSI numbers.

The mobile subscriber IMSI number information is calculated according to a predetermined policy.

The predetermined policy includes using the IMSI number, calculating by a hash function, or by a method specified by an operator.

The method further includes broadcasting, by the first MSC, load information to a BSC managed by the first MSC.

The method further includes broadcasting, by the first MSC, load information to other MSCs.

The method further includes broadcasting, by the first MSC, mobile subscriber homing information to the BSC managed by the first MSC.

When the load of the first MSC exceeds a predetermined value, the method further includes transmitting, by the first MSC, a load balancing request to the first BSC managed by the first MSC.

When the first BSC transfers the mobile subscriber from the first MSC to a second MSC, the method further includes transmitting, by the first BSC, a load balancing request to a second MSC.

When the load of the first MSC exceeds a predetermined value, the method further includes transmitting, by the first MSC, a load balancing request to other MSCs.

If the mapping relationship between the mobile subscriber and the MSC is changed, the first MSC receives a mobile subscriber request for terminating a session, notices the location of the mobile subscriber to a second MSC, and routs the call to the second MSC; and the second MSC is corresponding to the mobile subscriber according to the changed mapping relationship.

In the method, the second MSC registers the mobile subscriber to the second MSC through an implicit location registration method.

The second MSC initiates a called paging process according to mobile subscriber location information transmitted by the first MSC.

The second MSC routes the call to the second MSC through a method of feeding a roaming number back to the first MSC.

The method further includes mutually performing, by the first BSC and the first MSC, data checking.

The data checking may be initiated from the BSC to the MSC or may be initiated from the MSC to the BSC.

The data checking is used to check content of the number segment configuration table.

A BSC for implementing multi-homing in CDMA2000 including an air interface message transceiver unit configured to receive and transmit air interface messages and a processing unit configured to process air interface messages, further including:

a plurality of MSC interfacing units for interchanging information with a plurality of MSCs;

a mobile subscriber/MSC mapping relationship setting unit configured to set mapping relationships between mobile subscribers and MSCs.

The mobile subscriber/MSC mapping relationship setting unit acquires the MSC corresponding to the mobile subscriber according to a mobile subscriber identity carried in the air interface message acquired by the processing unit, and a corresponding MSC interfacing unit interchanges information with the MSC.

The mobile subscriber/MSC mapping relationship setting unit further includes:

a distributing and gathering unit configured to receive and forward messages transmitted by the processing unit to their corresponding MSC interfacing units; and receive and forward messages from a plurality of MSC interfacing units to the processing unit.

The mobile subscriber/MSC mapping relationship setting unit further includes:

a selecting unit configured to select a corresponding MSC according to an international mobile subscriber identification number parsed by the processing unit and transmit a selecting result to the distributing and gathering unit.

The mobile subscriber/MSC mapping relationship setting unit further includes:

a policy data generating unit configured to store operator policies, set the mapping relationships between the mobile subscribers and the MSCs and transmit the operator policies to the selecting unit.

The mobile subscriber/MSC mapping relationship setting unit further includes:

a first load balancing requesting unit configured to transmit load balancing requests to the MSC.

The mobile subscriber/MSC mapping relationship setting unit further includes:

a first data checking unit configured to transmit data checking information to the MSC.

A network for implementing BSC multi-homing in CDMA2000 including a plurality of BSCs and a plurality of MSCs, wherein each of the BSCs includes an air interface message transceiver unit configured to receive and transmit air interface messages and a processing unit configured to process the air interface messages, and further includes:

a plurality of MSC interfacing units for interchanging information with a plurality of MSCs;

a mobile subscriber/MSC mapping relationship setting unit configured to set mapping relationships between mobile subscribers and MSCs.

The mobile subscriber/MSC mapping relationship setting unit acquires the MSC corresponding to the mobile subscriber according to a mobile subscriber identity carried in the air interface message acquired by the processing unit, and a corresponding MSC interfacing unit interchanges information with the MSC.

The mobile subscriber/MSC mapping relationship setting unit further includes:

a distributing and gathering unit configured to receive and forward messages transmitted by the processing unit to their corresponding MSC interfacing units; and receive and forward messages from a plurality of MSC interfacing units to the processing unit.

The mobile subscriber/MSC mapping relationship setting unit further includes:

a selecting unit configured to select a corresponding MSC according to an international mobile subscriber identification number parsed by the processing unit and transmit a selecting result to the distributing and gathering unit.

The mobile subscriber/MSC mapping relationship setting unit further includes:

a policy data generating unit configured to store operator policies, set the mapping relationships between the mobile subscribers and the MSCs and transmit the operator policies to the selecting unit.

The network further includes:

at least one of a first load balancing requesting unit, located at the BSC, for transmitting load balancing requests to the MSC, and

a second load balancing requesting unit, located at the MSC, for transmitting load balancing requests to the BSC.

The network further includes:

at least one of a first data checking unit, located at the BSC, for transmitting data checking information to the MSC, and

a second data checking unit, located at the MSC, for transmitting data checking information to the BSC.

A device for implementing BSC multi-homing in CDMA2000 including MSC interfaces for interchanging information with MSCs and BSC interfaces for interchanging information with BSCs, further including:

a mobile subscriber/MSC mapping relationship setting unit configured to set mapping relationships between mobile subscribers and MSCs.

The mobile subscriber/MSC mapping relationship setting unit acquires information on the MSC corresponding to the mobile subscriber according to a mobile subscriber identity, and connects the MSC to a corresponding BSC via the MSC interface and the BSC interface.

The mobile subscriber/MSC mapping relationship setting unit further includes:

a policy generator for storing homing policies of mobile subscribers and setting the mapping relationships between the mobile subscribers and the MSCs;

a load balancing control logical unit, connected to the MSC interface, the BSC interface and the policy generator, for receiving the homing policies of mobile subscribers transmitted from the policy generator, and homing the BSC to a corresponding MSC according to the homing policies of mobile subscribers.

The mobile subscriber/MSC mapping relationship setting unit further includes:

a data storage unit configured to store the mapping relationships between the mobile subscribers and the MSCs, transmitted by the load balancing control logical unit.

the mobile subscriber/MSC mapping relationship setting unit further includes:

a data checking and synchronization control logical unit configured to perform checking and synchronization on the BSC and the MSC according to policies generated by the policy generator and the mapping relationships between the mobile subscribers and the MSCs stored in the data storage unit.

The mobile subscriber/MSC mapping relationship setting unit further includes:

a load balancing control logical unit, connected to the policy generating unit, the data storage unit and the data checking and logical control unit, for performing load balancing processing on the MSC and the BSC.

A network for implementing BSC multi-homing in CDMA2000 including a plurality of BSCs and a plurality of MSCs, further including a device for implementing the BSC multi-homing, wherein the device for implementing the BSC multi-homing in CDMA2000 includes MSC interfaces for interchanging information with MSCs and BSC interfaces for interchanging information with BSCs, and further includes:

a mobile subscriber/MSC mapping relationship setting unit configured to set mapping relationships between mobile subscribers and MSCs.

The mobile subscriber/MSC mapping relationship setting unit acquires information on the MSC corresponding to the mobile subscriber according to a mobile subscriber identity, and connects the MSC to a corresponding BSC via the MSC interface and the BSC interface.

The mobile subscriber/MSC mapping relationship setting unit further includes:

a policy generator for storing homing policies of mobile subscribers and setting the mapping relationships between the mobile subscribers and the MSCs;

a load balancing control logical unit, connected to the MSC interface, the BSC interface and the policy generator, for receiving the homing policies of mobile subscribers transmitted from the policy generator, and homing the BSC to a corresponding MSC according to the homing policies of mobile subscribers.

In the network, the mobile subscriber/MSC mapping relationship setting unit further includes:

a data storage unit configured to store the mapping relationships between the mobile subscribers and the MSCs, transmitted by the load balancing control logical unit.

the mobile subscriber/MSC mapping relationship setting unit further includes:

a data checking and synchronization control logical unit configured to perform checking and synchronization on the BSC and the MSC according to policies generated by the policy generator and the mapping relationships between the mobile subscribers and the MSCs stored in the data storage unit.

The mobile subscriber/MSC mapping relationship setting unit further includes:

a load balancing control logical unit, connected to the policy generating unit, the data storage unit and the data checking and logical control unit, for performing load balancing processing on the MSC and the BSC.

The device for implementing the BSC multi-homing can be integrated with a BSC or a media gateway.

Some advantages of the present invention are as follows:

According to the present invention, utilizing the mapping relationships between the mobile subscribers and the MSCs, flexible homing relationships between the BSCs and the MSCs can be established and the BSCs are no longer be homed to only fixed MSCs, so the control relationships between a plurality of BSCs and MSCs can be achieved. Thus, network resources can be utilized sufficiently, and load balancing among network elements can be achieved.

According to the present invention, a BSC multi-homing service in the field of CDMA2000, which has the benefits of load balance, disaster tolerance, CD interface traffic reduction, inter-office handover reduction, etc., can be implemented.

### BRIEF DESCRIPTION OF THE DRAWINGS

FIG. 1 illustrates a networking mode of circuit domain of CDMA2000 in the related art;

FIG. 2 is a flow chart illustrating the ISPAGING method specified in ANSI41D protocol in the related art;

FIG. 3 is a flow chart illustrating a process in which a Base Station Controller (BSC) registers to an Mobile Switching Center (MSC) in the related art;

FIG. 4 is a flow chart illustrating a process in which a BSC initiates a call to an MSC in the related art;

FIG. 5 is a flow chart illustrating a process in which a BSC is called in the related art;

FIG. 6 is a schematic diagram illustrating a network structure for implementing multi-homing of radio access network in a WCDMA according to the related art;

FIG. 7 is a schematic diagram illustrating a structure of a BSC in a CDMA2000 according to the related art;

FIG. 8 is a schematic diagram illustrating a device for implementing BSC multi-homing in a CDMA2000 according to the present invention;

FIG. 9 is a schematic diagram illustrating a network structure for implementing BSC multi-homing in a CDMA2000 according to the present invention;

FIG. 10 is a schematic diagram illustrating a device for implementing BSC multi-homing in another CDMA2000 according to the present invention;

FIG. 11 is a main flow chart of the present invention;

FIG. 12 is a flow chart illustrating a process in which an MSC broadcasts load information to its subordinate BSCs according to the present invention;

FIG. 13 is a flow chart illustrating a process in which an MSC broadcasts load information to other MSCs according to the present invention;

FIG. 14 is a flow chart illustrating a process in which an MSC issues mobile subscriber homing information to its subordinate BSCs according to the present invention;

FIG. 15 is a flow chart illustrating a process in which an MSC initiates a load balancing request to a BSC according to the present invention;

FIG. 16 is a flow chart illustrating a process in which a BSC initiates a load balancing request to an MSC according to the present invention;

FIG. 17 is a flow chart illustrating a process in which an MSC initiates a load balancing request to other MSCs according to the present invention;

FIG. 18 is a flow chart of paging after load balancing according to the present invention;

FIG. 19 is another flow chart of paging after load balancing according to the present invention;

FIG. 20 is yet another flow chart of paging after load balancing according to the present invention;

FIG. 21 is a flow chart illustrating a process in which a BSC initiates data checking according to the present invention;

FIG. 22 is a flow chart illustrating a process in which an MSC initiates data checking according to the present invention;

FIG. 23 is a flow chart illustrating a process in which a load balanced MSC1 transmits a load balancing request to a BSC and is homed to another MSC according to the present invention;

FIG. 24 is a schematic diagram illustrating devices for implementing multi-homing of BSCs arranged at media gateways (MGWs) according to the present invention.

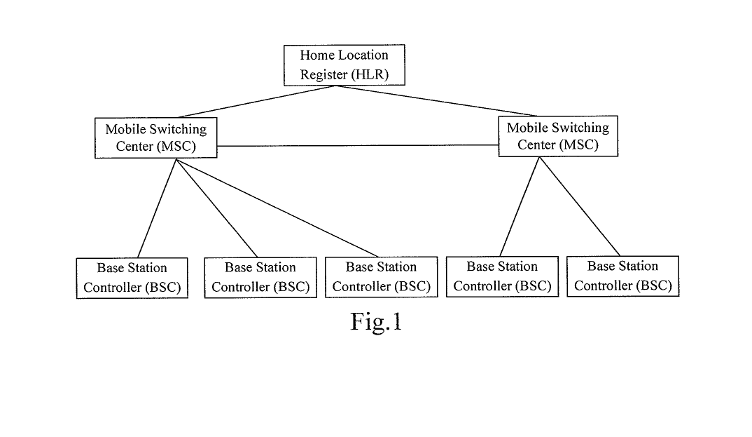

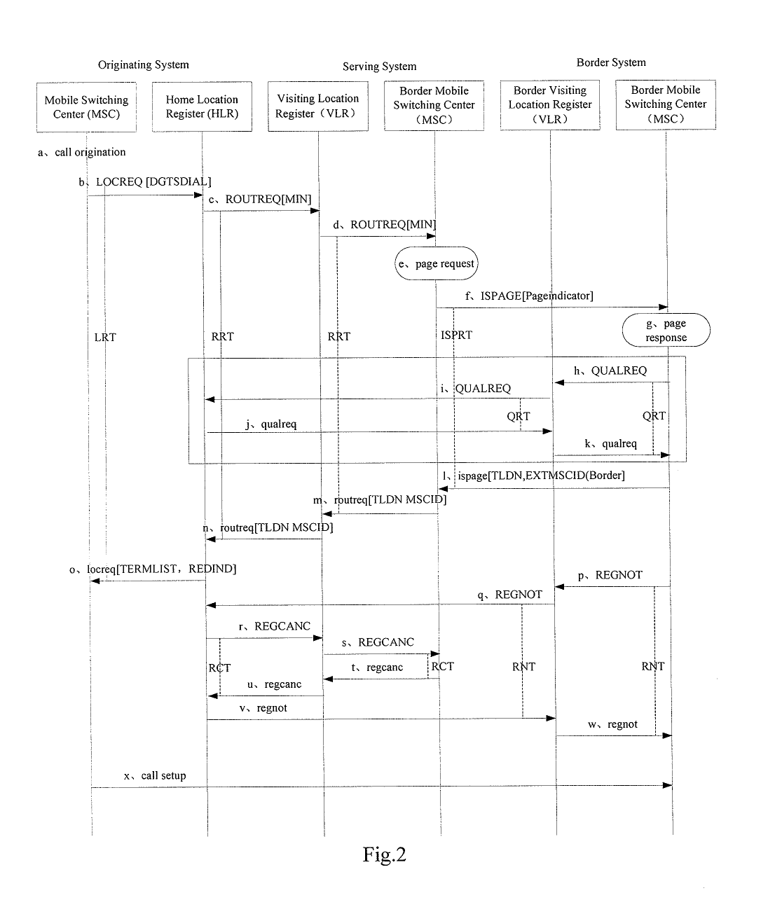

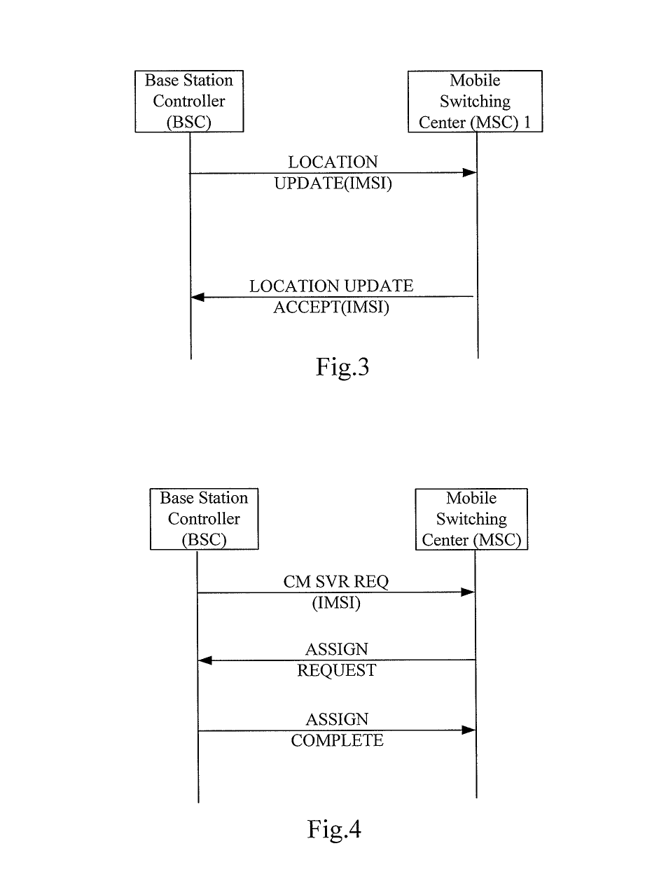

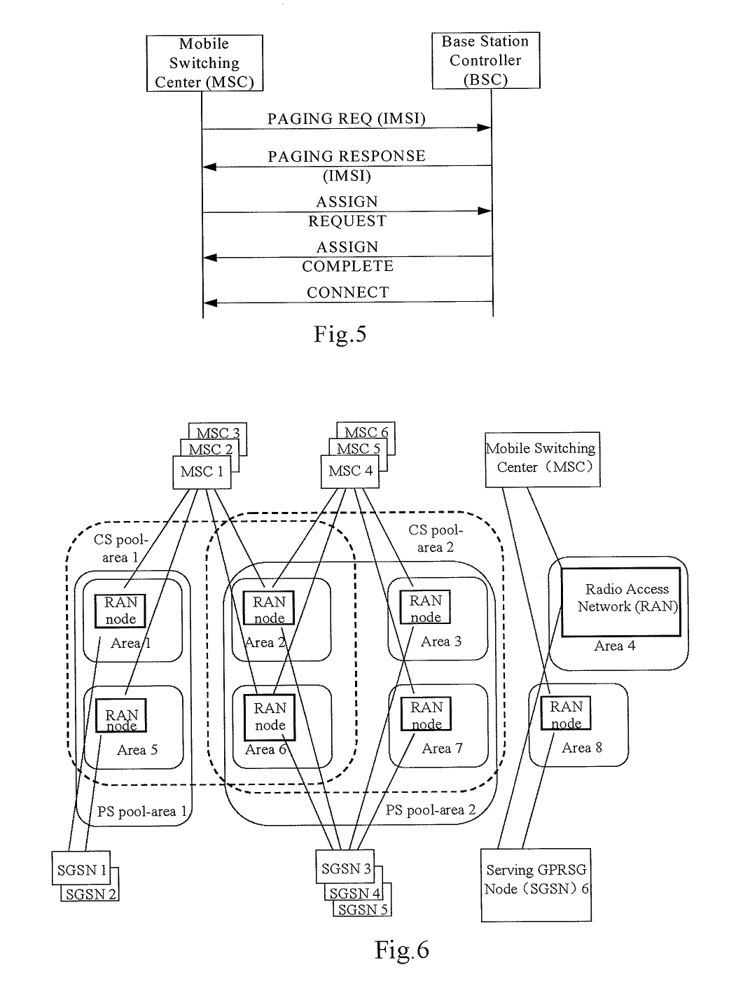

### DETAILED DESCRIPTION OF THE EMBODIMENTS

Embodiments of the present invention will now be described in conjunction with attached drawings.

Embodiments of the present invention are directed to implement Base Station Controller (BSC) multi-homing, thus achieving load balancing. The BSC may select an appropriate Mobile Switching Center (MSC) according to the IMSI information carried in a user message, and the selection rule can be adjusted dynamically as required so as to implement load balancing.

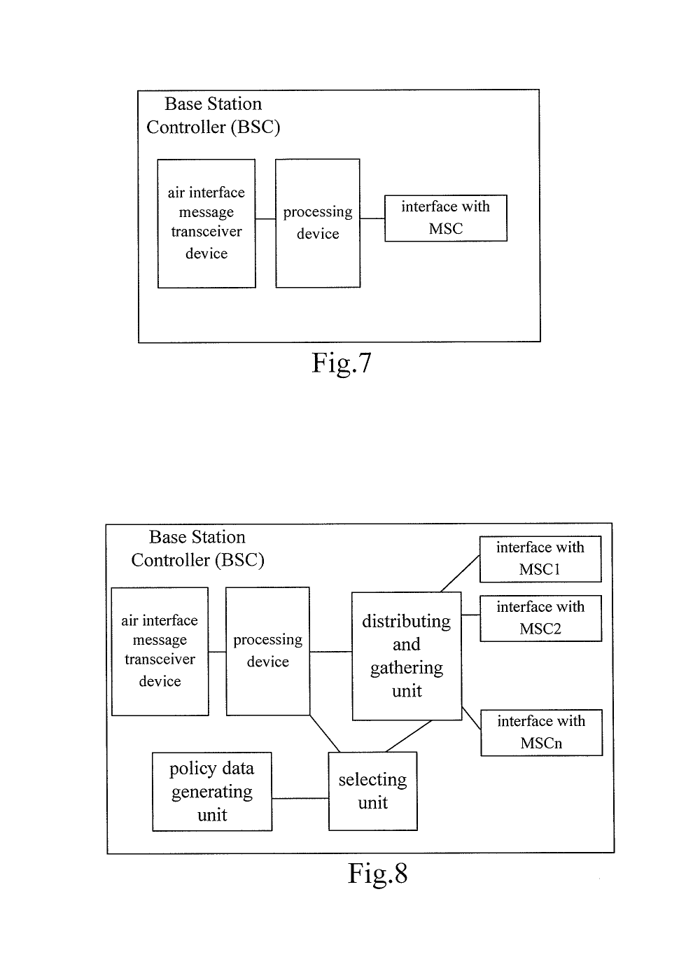

BSCs and MSCs may be included in an existing CDMA2000 network system. Mobile subscribers communicate with MSCs via BSCs. A BSC according to the related art as shown in FIG. 7 mainly includes:

an air interface message transceiver unit configured to receive and transmit air interface messages;

a processing unit configured to process air interface messages; and

an MSC interfacing unit configured to interface with an MSC.

In addition to the above components, the BSC according to the present invention further includes a mobile subscriber/MSC mapping relationship setting unit and a plurality of MSC interfaces, enabling the BSC to be homed to a plurality of MSCs. Therefore, BSC multi-homing can be achieved. FIG. 8 is a schematic diagram illustrating a device for implementing BSC multi-homing in a CDMA2000 according to the present invention. It can be seen from FIG. 8 that the following components are added to the BSC according to the related art:

a plurality of MSC interfacing units for interchanging information with a plurality of MSCs;

a mobile subscriber/MSC mapping relationship setting unit configured to set mapping relationships between mobile subscribers and MSCs.

The mobile subscriber/MSC mapping relationship setting unit according to the present invention further includes the following components:

a policy data generating unit configured to store operator policies, determine the mapping relationships between the mobile subscribers and the MSCs, and transmit the operator policies to a selecting unit;

the selecting unit configured to select a corresponding MSC according to an international mobile subscriber identification number parsed by the processing unit and transmit a selecting result to a distributing and gathering unit;

the distributing and gathering unit configured to receive and forward messages transmitted by the processing unit to their corresponding MSC interfacing units; and receive and forward messages from the plurality of MSC interfacing units to the processing unit.

The networking of the BSC generated according to the above solution can be implemented directly in such a way that it will be used in a network structure, the detailed description thereof is omitted.

According to the above solution, the mobile subscriber/MSC mapping relationship setting unit further includes the following components:

a first load balancing requesting unit configured to transmit load balancing requests to the MSC;

a first data checking unit configured to transmit data checking information to the MSC.

When the BSC is applied in network, the BSC and the MSC can perform load balancing and data checking mutually. Thus, similar to the BSC, the MSC may further include the following components:

a second load balancing requesting unit configured to transmit load balancing requests to the BSC;

a second data checking unit configured to transmit data checking information to the BSC.

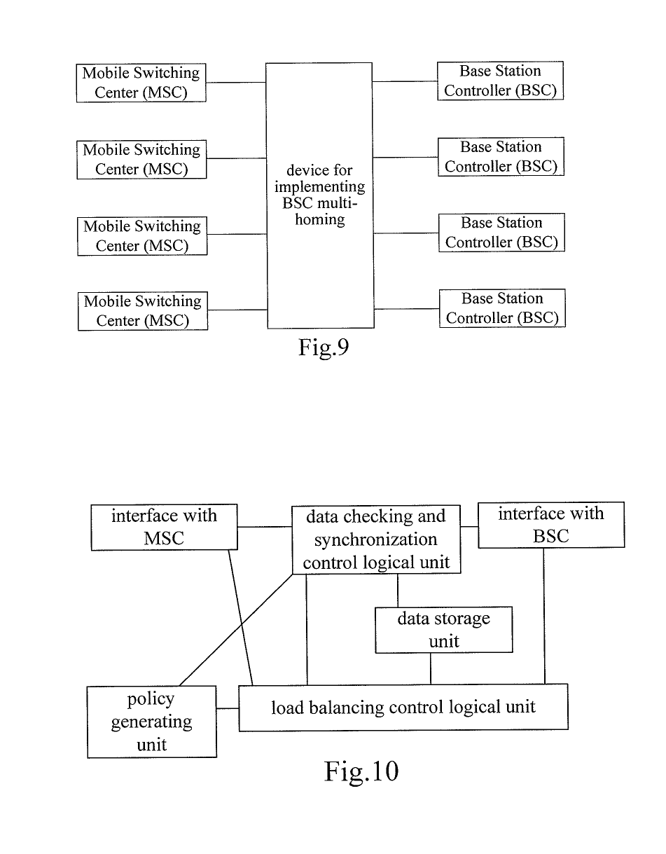

FIG. 9 is a schematic diagram illustrating another network structure for implementing BSC multi-homing in CDMA2000. It can be seen from FIG. 9 that a plurality of BSCs and MSCs are included in the network structure, and that another type of device for implementing BSC multi-homing is provided between the MSCs and the BSCs, as shown in FIG. 10. The device for implementing BSC multi-homing includes MSC interfaces for interchanging information with the MSCs and BSC interfaces for interchanging information with the BSCs, and further includes:

a mobile subscriber/MSC mapping relationship setting unit configured to set mapping relationships between mobile subscribers and MSCs, by acquiring information on the MSC corresponding to the mobile subscriber according to a mobile subscriber identity and connecting the MSC to a corresponding BSC via the MSC interface and the BSC interface.

The mobile subscriber/MSC mapping relationship setting unit further includes:

a policy generator for storing homing policies of mobile subscribers and setting the mapping relationships between the mobile subscribers and the MSCs;

a load balancing control logical unit, connected to the MSC interface, the BSC interface, and the policy generator, for receiving the homing policies of mobile subscribers transmitted from the policy generator, and homing the BSC to a corresponding MSC according to the homing policies of mobile subscribers;

a data storage unit configured to store BSC homing information transmitted by the load balancing control logical unit;

a data checking and synchronization control logical unit configured to perform checking and synchronization on the BSC and the MSC according to policies generated by the policy generator and the BSC homing information stored in the data storage unit.

The above-described device for implementing BSC multi-homing can be integrated with a BSC or a media gateway.

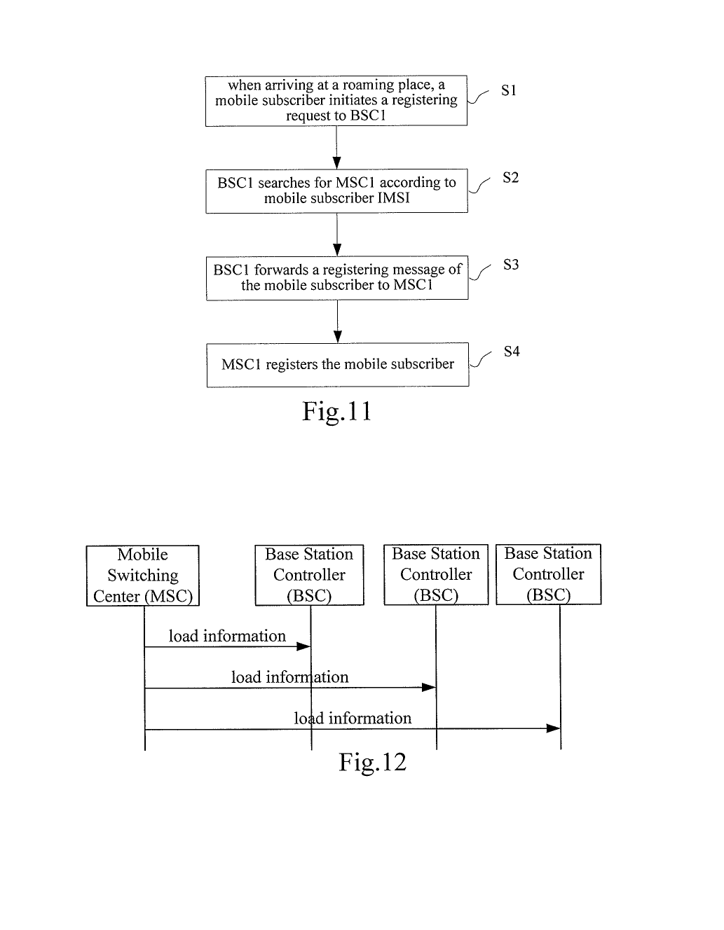

FIG. 11 is a main flow chart of the present invention, including the following:

S1. a mobile subscriber initiates a registering request to BSC1;

when arriving at a roaming place or requiring load balancing, the mobile subscriber initiates a registering request to BSC1 for requesting being registered to a new MSC1;

S2. BSC1 searches for MSC1 according to the IMSI of the mobile subscriber;

This step can be completed by a number segment configuration table set by the system. Mobile subscribers' IMSI number segments and their corresponding MSC IDs are arranged in the number segment configuration table. The mapping relationships can be determined according to a predefined policy and be stored in the BSC and the MSC. The number segments in the number segment configuration table can be actual IMSI number segments, or number segments calculated by a particular algorithm. The predetermined policy includes using the IMSI number, calculating by a hash function, or by a method specified by an operator.

The following table is a number segment configuration table.

TABLE 1a
number segment configuration table (actual IMSI number)

| IMSI number segment | MSCID |
|---|---|
| 46003090000xxxx | MSC1 |
| 46003090003xxxx | MSC1 |
| 4600309xxxxxxxx | MSC2 |
| 46003090001xxxx | MSC3 |
| . . . | . . . |

TABLE 1b
number segment configuration table

| IMSI number segment | MSCID |
|---|---|
| 1xx | MSC1 |
| 2xx | MSC1 |
| 3xx | MSC2 |
| 4xx | MSC3 |
| . . . | . . . |

(When looking up the table, a number from 0 to 999 can be obtained by performing a modulo operation on the IMSI number with the number 1000, and then the MSC identification can be obtained by looking up the table)

In this step, the MSCs corresponding to the mobile subscriber can be found according to the number segment table, enabling a BSC to be homed to a plurality of MSCs.

In addition, a number segment configuration table according to the present invention can be of various configurations depending on whether the table is stored in a BSC or in an MSC. For example, there are both IMSI number segments and MSC IDs in a number segment configuration table stored in a BSC, however, there can be only IMSI number segments in a number segment configuration table stored in an MSC, from which MSC IDs can be excluded. Table. 2 and 3 are examples of these two number segment configuration tables. Of course, the BSC and the MSC can also use the same number segment configuration table, for example, the number segment configuration table shown in table 2.

TABLE 2
a number segment configuration table stored in BSC

| IMSI number segment | MSCID |
|---|---|
| 46003090000xxxx | MSC1 |
| 46003090003xxxx | MSC1 |
| 4600309xxxxxxxx | MSC2 |
| 46003090002xxxx | MSC3 |
| . . . | . . . |

TABLE 3
a number segment configuration table stored in MSC
IMSI number segment
46003090000xxxx
46003090003xxxx

S3. BSC1 forwards a registering message of the mobile subscriber to MSC1;

BSC1 forwards the registering message of the mobile subscriber to MSC1 for requesting being registered to MSC1.

S4. The mobile subscriber registers to MSC1.

MSC1 registers for the mobile subscriber, enabling the mobile subscriber to process relevant services through MSC1.

By the above process, BSC multi-homing, and thus load balancing can be achieved by the registering of the mobile subscriber.

The present invention can be further optimized under the condition that a BSC can be homed to a plurality of MSCs.

FIG. 12 is a flow chart illustrating a process in which an MSC broadcasts load information to its subordinate BSCs. In FIG. 12, the MSC can broadcast its own load information to the BSCs periodically. The load information can be a remaining processing capacity of the device and can also be a processing capacity utilization ratio. According to the load information, the BSC can determine whether it is to be homed to other MSCs so as to achieve load balancing.

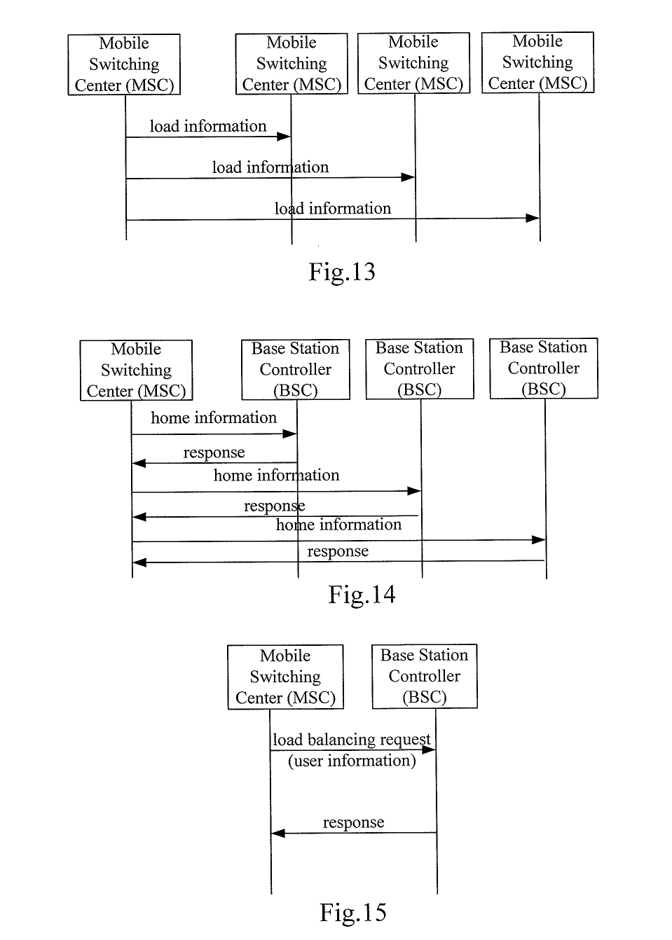

FIG. 13 is a flow chart illustrating a process in which an MSC broadcasts load information to other MSCs. In FIG. 13, the MSC broadcasts its own load information to the MSCs periodically.

FIG. 14 is a flow chart illustrating a process in which an MSC issues updated mobile subscriber homing information to a plurality of BSCs. In FIG. 14, after updating mobile subscriber homing information, the MSC issues the updated mobile subscriber homing information to the BSCs, and then the BSCs are required to feed a message back to the MSC after updating its mobile subscriber homing information.

FIG. 15 is a flow chart illustrating a process in which an MSC initiates a load balancing request to a BSC. If the load of the MSC exceeds a predetermined value, system performance can be deteriorated. The MSC can reduce its load by transmitting a request to its subordinate BSCs for balancing the load, enabling some of its subordinate BSCs to be homed to other MSCs.

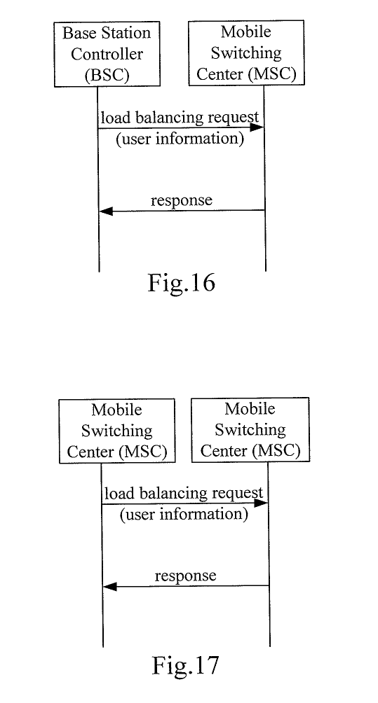

FIG. 16 is a flow chart illustrating a process in which a BSC initiates a load balancing request to an MSC. If the load of the BSC exceeds a predetermined value, system performance can also be deteriorated. The BSC can reduce its load by transmitting load balancing requests to its homed MSCs.

FIG. 17 is a flow chart illustrating a process in which an MSC initiates a load balancing request to an MSC. When the load of the MSC exceeds a predetermined value, system performance can be deteriorated. The MSC can reduce its load by transmitting load balancing requests to other MSCs, enabling some of the BSCs homed to the MSC to be homed to other MSCs.

After load balancing, the mapping relationship between the mobile subscriber and the MSC has been changed. Further, after receiving a mobile subscriber request for terminating a session, MSC1 to which the mobile subscriber was homed before the mapping relationship has been changed, informs MSC2 to which the mobile subscriber is homed after the mapping relationship has been changed, of the location of the mobile subscriber, and routes the call to MSC2. MSC2 can register the mobile subscriber to MSC2 by an implicit location registration method. The implicit location registration method is known to the skilled in the art and will not be described in detail herein. MSC2 can initiate a called paging process according to mobile subscriber location information transmitted by MSC1. MSC2 can also route the call to MSC1 by a method of feeding a roaming number (TLDN) back to MSC1.

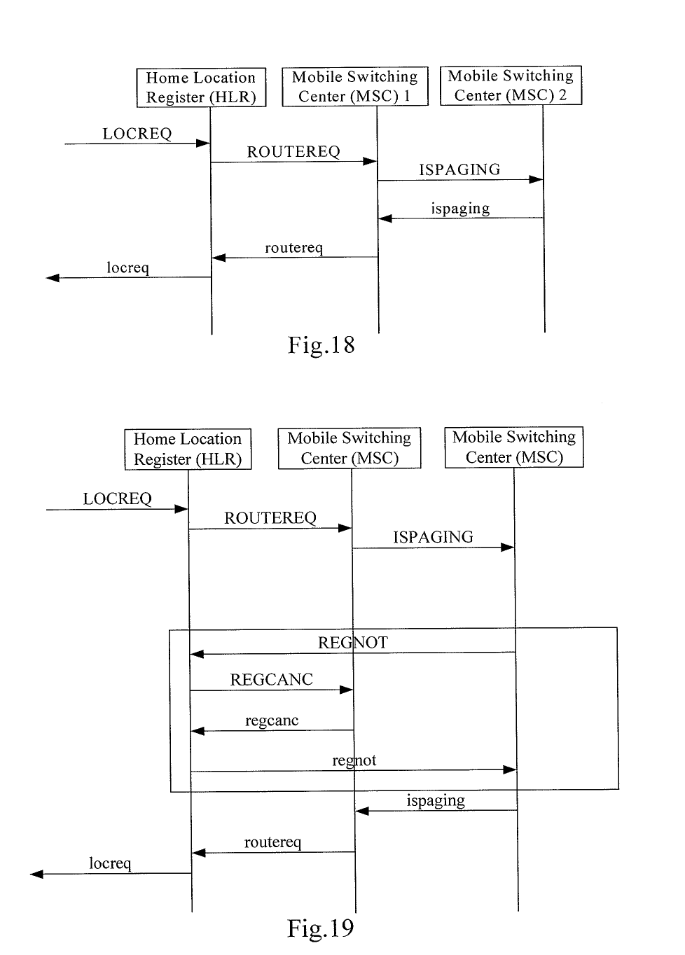

FIG. 18 is a flow chart of paging after load balancing. Again, ISPAGING messages are used in this solution.

When MSC1 finds that a user has transferred into another MSC (MSC2), it transmits an ISPAGING message to MSC2. When MSC2 receives the ISPAGING message, it returns a roaming number and MSCID directly to MSC1.

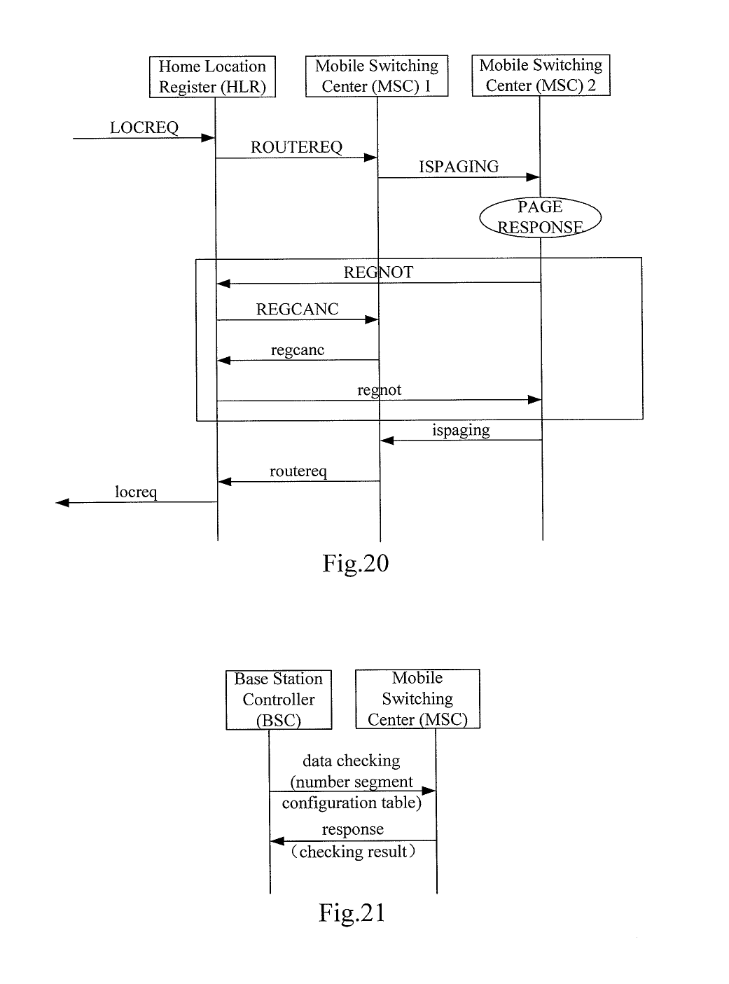

For the above paging solution, there can be two improved solutions shown in FIG. 19 and FIG. 20.

Referring to the solution shown in FIG. 19, in the paging process after load balancing has been changed, a location registration process is added.

Referring to the solution shown in FIG. 20, in the paging process after load balancing has been changed, after the paging has been responded to, location registration is performed and a roaming number is returned.

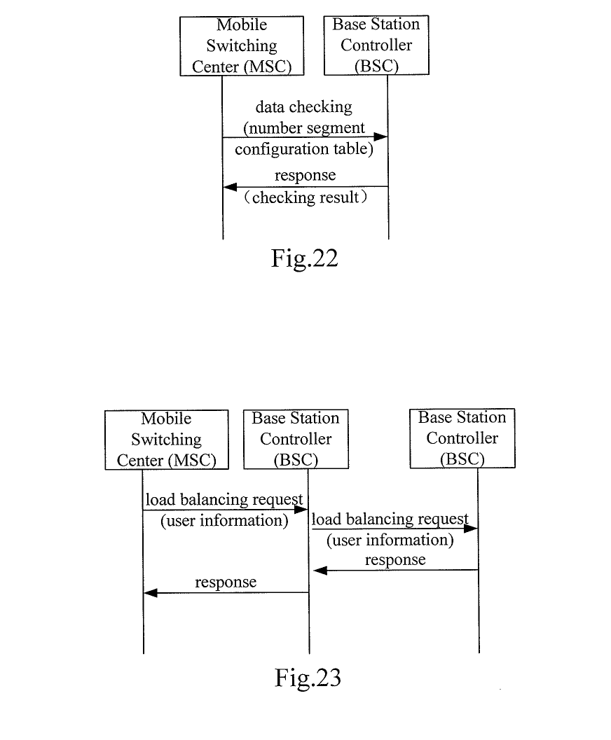

FIG. 21 and FIG. 22 are flow charts illustrating data checking processes of an MSC and a BSC, respectively. These data checking processes can be data checking initiated by the MSC or data checking initiated by the BSC. The data checking is used to check content of the number segment configuration table so as to guarantee the conformity of number segment configuration tables stored in the MSC and in the BSC.

FIG. 21 shows a data checking process initiated from the BSC to the MSC, and FIG. 22 shows a data checking process initiated from the MSC to the BSC.

Not all of the above solutions are necessary in practical applications, combinations of some of the above solutions can be used selectively depending on practical conditions. Examples of such combinations are as follows:

Combination 1: Load Balancing Process

When MSC1 needs to balance some of users to another MSC, MSC1 chooses MSC2 according to an operator policy so as to transmit a load balancing request to MSC2 and transmit to MSC2 a number segment intended to be received by MSC2, and MSC2 determines whether to accept the request according to the operator policy and its own condition. If MSC2 receives the request, it feeds a message indicating that the request has been accepted back to MSC1 and updates its own number segment configuration table. MSC2 instructs the BSC to update the number segment configuration table, and the BSC updates its own number segment configuration table according to the information.

Combination 2: Called Process After a User Has Been Transferred

When a user is transferred to MSC2 by the load balancing process, if the processes of registration and calling, etc. do not happen, the user pointer stored in the HLR still points to the original Mobile Switch Center MSC1. At this time, if a process in which the user is called happens, the HLR still requests MSC1 for a roaming number. The IS-PAGING process is reused to overcome this problem in this solution, wherein MSC1 initiates the IS-PAGING process to MSC2, with user location area information being carried, MSC2 returns a roaming number to MSC1, then MSC1 returns the roaming number to the HLR, at this time, the called process can be routed to MSC2 that initiates a call to the called user according to the user location area information in the process.

Combination 3: Load Balancing Process 2

When MSC1 needs to balance some of users to another MSC, MSC1 chooses the BSC based on an operator policy so as to transmit a load balancing request to the BSC and transmit to BSC1 a number segment intended to be given out.

The BSC chooses MSC2 as a load receiving target according to the operator policy and transmits to MSC2 a number segment intended to be received by MSC2. MSC2 determines whether to accept the request according to the operator policy and its own condition. If MSC2 receives the request, it feeds a message indicating that the request has been accepted back to the BSC and updates its own number segment configuration table. Subsequently, MSC2 broadcasts its own number segment configuration table to the BSC, and the BSC updates its number segment configuration table according to the information. After MSC1 has updated its own number segment configuration table, it also broadcasts the number segment configuration table to the BSC, so as to update the number segment configuration table in the BSC.

FIG. 23 is a flow chart of the above solution.

On the basis of combinations 1, 2 and 3, a process in which the MSC periodically broadcasts its load information to other MSCs or the BSC can be added. The method of selecting an MSC for receiving load in the load balancing process not only refers to the operator policy, but also refers to the load conditions of other MSCs.

Combination 4: Process of Data Conformity Checking

For ensuring data conformity, a data checking process is added on the basis of combination 1.

In the load balancing process, when the BSC receives a data updating message of MSC2, it transmits the amended data to MSC1 for confirmation. After the amended data is confirmed to be correct, an actual data amendment is made and a confirmation message is feed back to MSC2.

When the MSC is required to perform data checking, for example, periodical data checking according to an operator policy, it can also initiate a checking process to the BSC, and transmit an alerting message if the data of the MSC is not in conformity with that of the BSC.

Combination 5: Process 2 of Data Conformity Checking

When load is required to be adjusted, data updating can be performed manually for all of the MSCs and the BSCs, so as to transfer a mobile subscriber calling process and a registering process.

When the transferring of a user as a called party has not been completed, the transferring of a called user can be completed by a paging mechanism after load balancing.

According to the present invention, a BSC multi-homing service in the field of CDMA2000, which has the benefits of load balance, disaster tolerance, CD interface traffic reduction, inter-office handover reduction, etc., can be implemented.

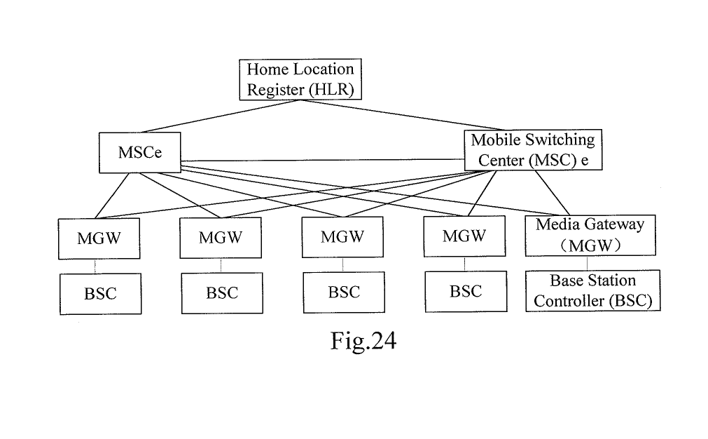

FIG. 24 is a schematic diagram illustrating devices for implementing multi-homing of BSCs arranged at media gateways (MGWs) according to the inventive solution. In FIG. 24, each of the BSCs has no multi-homing capability. An interface A of each of the BSCs is connected to an MGW, the MGM contains a device for implementing the BSC multi-homing and forwards a message to an appropriate MSC. The MSC e, which is in form of an improved MSC representing an MSC server having a soft-switching architecture, can be also an MSC.

It is evident that those skilled in the art may make various changes and modifications to the present invention without departing from the spirit and scope thereof. Thus, the present invention is intended to include these changes and modifications provided that they fall within the scope of the appended claims and equivalents thereof.

What is claimed is:

1. A method for implementing Base Station Controller (BSC) multi-homing in CDMA2000, comprising:
setting a mapping relationship between a mobile subscriber and a Mobile Switching Center (MSC);
receiving a message carrying the mobile subscriber identity;
searching for the mapping relationship according to the mobile subscriber identity to obtain a first MSC corresponding to the mobile subscriber; and
forwarding the message to the first MSC.

2. The method according to claim 1, wherein,
the searching for the mapping relationship comprises looking up a number segment configuration table;
wherein, the mapping relationship between the mobile subscriber and the MSC, International Mobile Subscriber Identification (IMSI) number information of the mobile subscriber, and a corresponding MSC identification are arranged in the number segment configuration table.

3. The method according to claim 2, wherein the mobile subscriber IMSI number information comprises one or more mobile subscriber IMSI numbers.

4. The method according to claim 2, wherein the mobile subscriber IMSI number information is calculated according to a predetermined policy.

5. The method according to claim 4, wherein the predetermined policy comprises using the IMSI number, calculating by a hash function, or by a method specified by an operator.

6. The method according to claim 1, further comprising broadcasting, by the first MSC, load information to a BSC managed by the first MSC.

7. The method according to claim 1, further comprising broadcasting, by the first MSC, load information to other MSCs.

8. The method according to claim 1, further comprising broadcasting, by the first MSC, mobile subscriber homing information to the BSC managed by the first MSC.

9. The method according to claim 1, further comprising transmitting, by the first MSC, a load balancing request to the first BSC managed by the first MSC, when load of the first MSC exceeds a predetermined value.

10. The method according to claim 9, further comprising transmitting, by the first BSC, a load balancing request to a second MSC, when the first BSC transfers the mobile subscriber from the first MSC to the second MSC.

11. The method according to claim 1, further comprising transmitting, by the first MSC, a load balancing request to other MSCs, when load of the first MSC exceeds a predetermined value.

12. The method according to claim 1,
wherein, if the mapping relationship between the mobile subscriber and the MSC is changed, the first MSC receives a mobile subscriber request for terminating a session, notices the location of the mobile subscriber to a second MSC, and routs the call to the second MSC; and
wherein the second MSC is corresponding to the mobile subscriber according to the changed mapping relationship.

13. The method according to claim 12, wherein the second MSC registers the mobile subscriber to the second MSC through an implicit location registration method.

14. The method according to claim 12, wherein the second MSC initiates a called paging process according to mobile subscriber location information transmitted by the first MSC.

15. The method according to claim 12, wherein the second MSC routes the call to the second MSC through a method of feeding a roaming number back to the first MSC.

16. The method according to claim 2, further comprising mutually performing, by the first BSC and the first MSC, data checking.

17. The method according to claim 16, wherein the data checking may be initiated from the BSC to the MSC or may be initiated from the MSC to the BSC.

18. The method according to claim 17, wherein the data checking is used to check content of the number segment configuration table.

19. A Base Station Controller (BSC) for implementing multi-homing in CDMA2000, comprising:
an air interface message transceiver unit configured to receive and transmit air interface messages;
a processing unit configured to process air interface messages;
a plurality of Mobile Switching Center (MSC) interfacing units configured to interchange information with the plurality of MSCs; and
a mobile subscriber/MSC mapping relationship setting unit configured to set mapping relationships between mobile subscribers and MSCs; wherein
the mobile subscriber/MSC mapping relationship setting unit acquires the MSC corresponding to the mobile subscriber according to a mobile subscriber identity carried in the air interface message acquired by the processing unit, and a corresponding MSC interfacing unit interchanges information with the MSC.

20. The BSC according to claim 19, wherein the mobile subscriber/MSC mapping relationship setting unit further comprises:
a distributing and gathering unit configured to receive and forward messages transmitted by the processing unit to their corresponding MSC interfacing units; and receive and forward messages from a plurality of MSC interfacing units to the processing unit.

21. The BSC according to claim 20, wherein the mobile subscriber/MSC mapping relationship setting unit further comprises:
a selecting unit configured to select a corresponding MSC according to an international mobile subscriber identification number parsed by the processing unit and transmit a selecting result to the distributing and gathering unit; and
a policy data generating unit configured to store operator policies, set the mapping relationships between the mobile subscribers and the MSCs and transmit the operator policies to the selecting unit.

22. The BSC according to claim 19, wherein the mobile subscriber/MSC mapping relationship setting unit further comprises:
a first load balancing requesting unit configured to transmit load balancing requests to the MSC.

23. The BSC according to claim 19, wherein the mobile subscriber/MSC mapping relationship setting unit further comprises:
a first data checking unit configured to transmit data checking information to the MSC.

24. A system for implementing Base Station Controller (BSC) multi-homing in CDMA2000 comprising a plurality of BSCs and a plurality of Mobile Switching Centers (MSCs), wherein each of the BSCs comprises:
an air interface message transceiver unit configured to receive and transmit air interface messages;
a processing unit configured to process the air interface messages;
a plurality of MSC interfacing units configured to interchange information with a plurality of MSCs; and
a mobile subscriber/MSC mapping relationship setting unit configured to set mapping relationships between mobile subscribers and MSCs; wherein
the mobile subscriber/MSC mapping relationship setting unit acquires the MSC corresponding to the mobile subscriber according to a mobile subscriber identity carried in the air interface message acquired by the processing unit, and a corresponding MSC interfacing unit interchanges information with the MSC.

25. The system according to claim 24, wherein the mobile subscriber/MSC mapping relationship setting unit further comprises:
a distributing and gathering unit configured to receive and forward messages transmitted by the processing unit to their corresponding MSC interfacing units; and receive and forward messages from a plurality of MSC interfacing units to the processing unit.

26. The system according to claim 25, wherein the mobile subscriber/MSC mapping relationship setting unit further comprises:
a selecting unit configured to select a corresponding MSC according to an international mobile subscriber identification number parsed by the processing unit and transmit a selecting result to the distributing and gathering unit.

27. The system according to claim 26, wherein the mobile subscriber/MSC mapping relationship setting unit further comprises:
a policy data generating unit configured to store operator policies, set the mapping relationships between the mobile subscribers and the MSCs and transmit the operator policies to the selecting unit.

28. The system according to claim 24, further comprising:
at least one of a first load balancing requesting unit, located at the BSC, configured to transmit load balancing requests to the MSC, and a second load balancing requesting unit, located at the MSC, configured to transmit load balancing requests to the BSC.

29. The system according to claim 24, further comprising:
at least one of a first data checking unit, located at the BSC, configured to transmit data checking information to the MSC, and a second data checking unit, located at the MSC, configured to transmit data checking information to the BSC.

30. A device for implementing Base Station Controller (BSC) multi-homing in CDMA2000, comprising:
Mobile Switching Center (MSC) interfaces configured to interchange information with MSCs;
BSC interfaces configured to interchange information with BSCs; and
a mobile subscriber/MSC mapping relationship setting unit configured to set mapping relationships between mobile subscribers and MSCs; wherein
the mobile subscriber/MSC mapping relationship setting unit acquires information on the MSC corresponding to the mobile subscriber according to a mobile subscriber identity, and connects the MSC to a corresponding BSC via the MSC interface and the BSC interface.

31. The device according to claim 30, wherein the mobile subscriber/MSC mapping relationship setting unit further comprises:
a policy generator configured to store homing policies of mobile subscribers and setting the mapping relationships between the mobile subscribers and the MSCs;
a load balancing control logical unit, connected to the MSC interface, the BSC interface and the policy generator, configured to receive the homing policies of mobile subscribers transmitted from the policy generator, and homing the BSC to a corresponding MSC according to the homing policies of mobile subscribers.

32. The device according to claim 31, wherein the mobile subscriber/MSC mapping relationship setting unit further comprises:
a data storage unit configured to store the mapping relationships between the mobile subscribers and the MSCs, transmitted by the load balancing control logical unit.

33. The device according to claim 31, wherein the mobile subscriber/MSC mapping relationship setting unit further comprises:
a data checking and synchronization control logical unit configured to perform checking and synchronization on the BSC and the MSC according to policies generated by the policy generator and the mapping relationships between the mobile subscribers and the MSCs stored in the data storage unit.

34. The device according to claim 33, wherein the mobile subscriber/MSC mapping relationship setting unit further comprises:
a load balancing control logical unit, connected to the policy generating unit, the data storage unit and the data checking and logical control unit, configured to perform load balancing processing on the MSC and the BSC.

35. A system for implementing Base Station Controller (BSC) multi-homing in CDMA2000 comprising a plurality of BSCs, a plurality of Mobile Switching Centers (MSCs) and a device for implementing the BSC multi-homing, wherein the device for implementing the BSC multi-homing comprises:
MSC interfaces configured to interchange information with MSCs;
BSC interfaces configured to interchange information with BSCs, and;
a mobile subscriber/MSC mapping relationship setting unit configured to set mapping relationships between mobile subscribers and MSCs; wherein
the mobile subscriber/MSC mapping relationship setting unit acquires information on the MSC corresponding to the mobile subscriber according to a mobile subscriber identity, and connects the MSC to a corresponding BSC via the MSC interface and the BSC interface.

36. The system according to claim 35, wherein the mobile subscriber/MSC mapping relationship setting unit further comprises:
a policy generator configured to store homing policies of mobile subscribers and setting the mapping relationships between the mobile subscribers and the MSCs;
a load balancing control logical unit, connected to the MSC interface, the BSC interface and the policy generator, configured to receive the homing policies of mobile subscribers transmitted from the policy generator, and homing the BSC to a corresponding MSC according to the homing policies of mobile subscribers.

37. The system according to claim 36, wherein the mobile subscriber/MSC mapping relationship setting unit further comprises:
a data storage unit configured to store the mapping relationships between the mobile subscribers and the MSCs, transmitted by the load balancing control logical unit.

38. The system according to claim 36, wherein the mobile subscriber/MSC mapping relationship setting unit further comprises:
a data checking and synchronization control logical unit configured to perform checking and synchronization on the BSC and the MSC according to policies generated by the policy generator and the mapping relationships between the mobile subscribers and the MSCs stored in the data storage unit.

39. The system according to claim 38, wherein the mobile subscriber/MSC mapping relationship setting unit further comprises:
a load balancing control logical unit, connected to the policy generating unit, the data storage unit and the data checking and logical control unit, configured to perform load balancing processing on the MSC and the BSC.

40. The system according to claim 37, wherein the device configured to implement the BSC multi-homing can be integrated with a BSC or a media gateway.
